(19) United States
(12) Patent Application Publication
(10) Pub. No.: US 2004/0183785 A1
(43) Pub. Date: Sep. 23, 2004

(54) WIRELESS INPUT APPARATUS AND RELATED METHOD FOR SUPPORTING INPUT REQUIREMENTS OF MULTIPLE HOSTS

(76) Inventors: Chuan-Wei Liu, Taipei Hsien (TW); Chien-Yi Shih, Taipei Hsien (TW)

Correspondence Address: NAIPO (NORTH AMERICA INTERNATIONAL PATENT OFFICE), P.O. BOX 506, MERRIFIELD, VA, 22116, US

(21) Appl. No.: 10/605,613

(22) Filed: Oct. 14, 2003

(30) Foreign Application Priority Data
Mar. 21, 2003 (TW) 092106395

(51) Int. Cl. G09G 5/00

(52) U.S. Cl. 345/168

(57) ABSTRACT

An input apparatus for an electronic system with a plurality of hosts. Each of the input apparatuses and the hosts has a radio module. Each radio module has a unique identity and is capable of transmitting and receiving radio packet signals. When the radio module of a host receives a packet including the identity of the host, the host will resolve information in the packet. If the host receives a packet including an identity of another host, the host will discard and ignore the packet. The input apparatus also has an input interface, and stores the identities of the hosts. A user can select a host identity with the input interface, and the radio module of the input apparatus will transmit packets including the selected identity and commands inputted with the input interface, such that the host corresponding to the selected identity will receive commands inputted by the user without interfering with other hosts.

### BACKGROUND OF INVENTION

1. Field of the Invention

The present invention relates to a wireless input apparatus such as a wireless keyboard, a mouse, or a touch panel, and more particularly, to a wireless input apparatus for supporting input requirements of multiple hosts.

2. Description of the Prior Art

In the information age, all kinds of data and image signals are interchanged, transmitted, and controlled in forms of electronic signals. Therefore, various electronic apparatuses, such as mobile phones, personal digital assistants (PDA), notebooks, and personal computers (PC) become important hardware devices. As semiconductor technology progresses, the costs of electronic apparatuses are substantially reduced. A user may have many different electronic apparatuses for different purposes.

When utilizing these electronic apparatuses, different input interfaces are required to input commands or data to different electronic apparatuses. However, different input interfaces have different operation methods, and it is very inconvenient to adapt different input interfaces for users. Moreover, since the size of electronic apparatuses becomes smaller, the input interface correspondingly becomes smaller, but less convenient. For example, mobile phones can transmit messages and store user”s data, but the mobile phone keyboard is not easy to use to input data. PDAs permit input by hand writing, but the input accuracy is not good enough. Relatively, the input interface of personal computers and notebooks is more convenient and efficient for users. In the prior art, an input interface having a multiplexer can be employed by two computer hosts, nevertheless, an input interface that can be employed by different kinds of electronic apparatuses does not exist so far. A user has to use different input interfaces to input to different electronic apparatuses.

Please refer to FIG. 1. FIG. 1 is a function block diagram of an electronic system 10 of the prior art. Hosts 14A and 14B are two electronic apparatuses sharing a keyboard 16, each having a processing module 18A and 18B, a volatile memory (such as RAM) 24A and 24B, and a non-volatile storage device (such as hard disc or CD-ROM) 26A and 26B. The processing modules 18A and 18B each include a processor (such as CPU) 20A and 20B, and a chip set 22A and 22B. The operation methods of the hosts 14A and 14B are identical. Take the host 14A for example, the processor 20A is for controlling the host 14A, the memory 24A is for holding data temporarily, the storage device 26A is for storing a great quantity of data in a non-volatile way, and the chip set 22A is for controlling data transmission among the processor 20A, the memory 24A, and the storage device 26A. The host 14A further includes an input port 17A (the host 14B includes an input port 17B as well) for receiving input signals from a keyboard 16, such that the processor 20A can control the host 14A according to the input signals received by the input port 17A. Moreover, the multiplexer 12 is connected to the keyboard 16 in one end through a transmission line 29C, and two output ports 19A and 19B of the multiplexer 12 are respectively connected to the inputs port 17A and 17B of the hosts 14A and 14B through two transmission lines 29A and 29B. The multiplexer 12 is a switch, which can be controlled by the user to selectively transmit input signals from the keyboard 16 to the host 14A or 14B. For example, when the multiplexer 12 is switched to the output port 19A (as shown in FIG. 1), the user can input data and commands to the host 14A from the keyboard 16 through the transmission lines 29A and 29C. On the other hand, when the multiplexer 12 is switched to the output port 19B, the user can input data and commands to the host 14B from the keyboard 16 through the transmission lines 29B and 29C.

The multiplexer 12 of the prior art is defective in practice, even though it allows two different hosts sharing the same input interface (i.e. the keyboard 16). First, the prior art multiplexer 12 requires real layouts (i.e. the transmission lines 29A, 29B, and 29C) and manual operation to switch. Also, the amount of hosts that the multiplexer 12 can support is limited by hardware. For example, the multiplexer 12 shown in FIG. 1 only has two output ports 19A and 19B, which only allows supporting two hosts. Furthermore, the input ports 17A and 17B need to be identical (for example, same terminal size), which also limits application of the prior art. As mentioned above, since the size of electronic apparatuses becomes smaller, it is difficult to design a standard input port for different electronic apparatuses.

In fact, a wireless input interface (such as a wireless keyboard) that allows users to input data to a host without any transmission lines and real input port exists in the prior art. However, the wireless keyboard of the prior art only allows inputting to a single host. Additionally, the interference between different wireless keyboards is a problem. For example, a wireless keyboard A is the input interface of a host A, and a wireless keyboard B is the input interface of a host B. If locations of the host A and host B are close, it is possible for the host B to receive data and commands that are supposed to be transmitted to the host A.

### SUMMARY OF INVENTION

It is therefore a primary objective of the claimed invention to provide a wireless input apparatus for supporting multiple hosts (electronic apparatuses), such that different hosts can share a wireless input interface. A user can select input to any one of the hosts, while other hosts are not interfered with.

According to the claimed invention, radio modules capable of interchanging data under a standard communication protocol are installed in an input apparatus and each hosts. Under the standard protocol, the input apparatus and each host have distinct identities, and the identities of each host are stored in the input apparatus. When a user wants to input data and commands to a specific host, the input apparatus will build a wireless connection with the specific host according to the host identity stored in the input apparatus, and send out a packet including the data, commands, and host identity, and all the radio modules of each hosts will receive the packet. The selected host will accept the packet and resolve the contents of the packet because the identity packeted in the packet is identical to its own identity. And for the other hosts, they will discard the packet because the identity packeted in the packet is not identical to their own identities. In this case, the user can input data and commands to different hosts by a single input apparatus.

In the claimed invention, the input apparatus is a wireless input apparatus, so transmission lines and standard output ports of the input apparatus and hosts are not necessary. The amount of hosts that the input apparatus of the claimed invention can support depends on the numbers of identities stored in the input apparatus, rather than the hardware limitation. Moreover, only the selected host accepts the input data and commands, so interference will not happen.

These and other objectives of the present invention will no doubt become obvious to those of ordinary skill in the art after having read the following detailed description of the preferred embodiment that is illustrated in the various figures and drawings.

### BRIEF DESCRIPTION OF DRAWINGS

FIG. 1 is a function block diagram of an electronic system of the prior art.

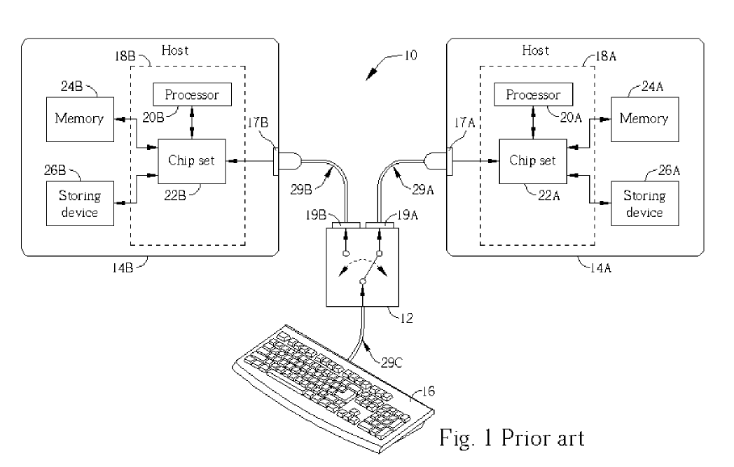

FIG. 2 is a function block diagram of an electronic system of the present invention.

FIG. 3 is a flow chart of the operational procedure of the electronic system shown in FIG. 2.

FIG. 4 is a function block diagram of another embodiment of the electronic system shown in FIG. 2.

FIG. 5 is a flow chart of a registration mode of the electronic system shown in FIG. 4.

FIG. 6 is a schematic diagram of the input apparatus in an embodiment of the present invention.

### DETAILED DESCRIPTION

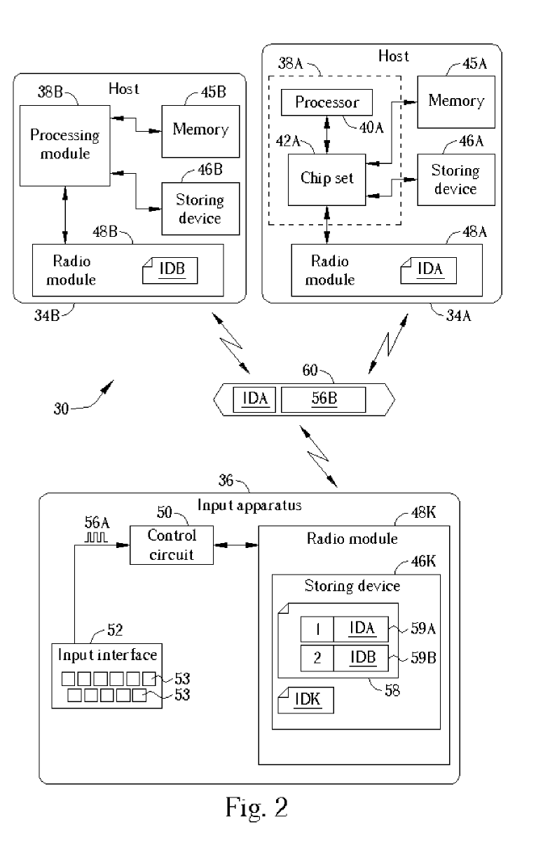

Please refer to FIG. 2. FIG. 2 is a function block diagram of an electronic system 30 of the present invention. The electronic system 30 utilizes a wireless input apparatus 36 as an input interface for supporting input requirement of multiple hosts (such as the host 34A and 34B shown in FIG. 2). The hosts 34A and 34B each include a processing module 38A and 38B, a volatile memory 45A and 45B, a non-volatile storage device 46A and 46B, and a radio module 48A and 48B. The host 34A can be a personal computer or a notebook. The processing module 38A includes a processor 40A for controlling the host 34A, and a chip set 42A for controlling data transmission among the processor 40A, the memory 45A, and the storage device 46A. The host 34B can be a personal digital assistant, and is controlled by the processing module 38B. The memory of each host is used to hold data and programs that the corresponding processing module needs, and the storage device of each hosts is for storing data in a non-volatile way. Furthermore, the input apparatus 36 includes an input interface 52, a control circuit 50, a radio module 48K, and a storage device 46K. The control circuit 50 is used to control the input apparatus 36. In a preferred embodiment of the present invention, the input apparatus 36 is a wireless keyboard, and the input interface 52 includes a plurality of keys 53. When a user presses different keys 53, the input interface 52 will correspondingly generate different control signals 56A, and transmit the control signals 56A to the control circuit 50. The storage device 46K is used to store data in a non-volatile way, and the storage device 46K includes an identity table 58 as shown in FIG. 2. The identity table 58 has plural columns (such as columns 59A and 59B), and the user can select transmitting data of any one column in the identity table 58 to the control circuit 50.

In the present invention, the radio modules of each host and the input apparatus 36 are capable of supporting the same radio communication protocol, so as to transmit and receive data and signals in forms of radio waves. Under standard communication protocol, each radio module has a unique identity. As shown in FIG. 2, the radio modules (48A and 48B) of the hosts (34A and 34B) correspond to different identities IDA and IDB (the radio modules 48A and 48B can each have a non-volatile storage device for storing corresponding identities IDA and IDB). Similarly, the radio module 48K of the input apparatus 36 stores its identity IDK and related settings in the storage device 46K. Under standard communication protocol, each radio module supports at least the following wireless network operation:

1. Each radio module can transmit, receive, and resolve radio packets in specific form under standard communication protocol. When a radio module A transmits data to a radio module B, the data is packeted in a packet, and the identity of the radio module B is also added in the packet for designating the radio module B as a transmitting target. After a radio module receives a packet and resolves the packet, the packet will be discarded if the identity stored in the packet is not identical to the identity of the radio module. On the other hand, if the identity stored in the packet is identical to the identity of the radio module, the data of the packet will be resolved and transmitted to corresponding processing module.

2. A radio module A is capable of initiating a handshaking procedure to request a radio module B to make a connection. The radio module A can designate the identity of the radio module B in a service request packet, such that the radio module B can accept the service request packet and proceed the handshaking procedure with the radio module A. During the handshaking procedure, the radio modules A and B can exchange related parameters, such as radio data transmitting rate, radio signal modulation mode, or even encoding/decoding method, via radio signals. For example, the radio module A can coordinate a specific frequency-hopping series with the radio module B, so that the radio module A can modulate the frequency of the packet that will be transmitted to the radio module B during the wireless network connection. On the other hand, the radio module B can demodulate the packets with different frequencies according to the frequency-hopping series. In this case, even if another radio module C intercepts the packets, the radio module C is not capable of receiving and resolving the packets without correct demodulating frequency. Moreover, the method of encryption/decryption can be also coordinated during the handshaking procedure for ensuring the safety of wireless data exchange between the radio module A and radio module B.

3. A radio module can detect the conditions of the other radio modules within the accessible radio signal range. For example, a radio module A can transmit a service request packet having its own identity but without designating the identity of the target radio module, and each radio module that receives the service request packet will send back a service notice packet having its identity (and other related data), such that the host of the radio module A can be aware of conditions of other hosts.

After the above-mentioned operations, each radio module of the electronic system 30 of the present invention can be aware of each other, and initiate the handshaking procedure. By performing the handshaking procedure, the packets transmitted between two radio modules will not be received and resolved by other radio modules. In the present invention, the connection between the input apparatus 36 and a specific host allows the specific host to receive and resolve the packets having data and commands that the user input via the input apparatus 36. The columns of the identity table 58 are used to store the identities of corresponding hosts. As shown in FIG. 2, the columns 59A and 59B of the identity table 58 each store the identities IDA and IDB of the radio modules 48A and 48B corresponding to the hosts 34A and 34B, thus the input apparatus 36 can input data in the hosts 34A and 34B. In other words, the identities IDA and IDB corresponding to the radio modules 48A and 48B respectively represent the hosts 34A and 34B, and the identity IDK corresponding to the radio module 48K represents the input apparatus 36.

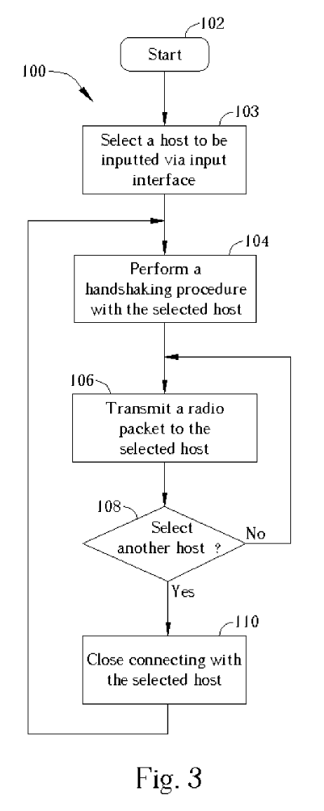

Please refer to FIG. 3 (and FIG. 2 as well). FIG. 3 is a flow chart of the operational procedure 100 of the electronic system shown in FIG. 2. As shown in FIG. 3, the operational procedure 100 includes following steps:

Step 102: start.

Step 103: the user selects a target host to be inputted via an input interface 52 of the input apparatus 36. For example, if the user wants to input data to the host 34A, the user can select the identity IDA that represents the host 34A from the column 59A of the identity table 58 on the input interface 52, and transmit the identity IDA of the host 34A to the control circuit 50.

Step 104: the control circuit 50 can initiate the handshaking procedure between the radio module 48K and the host 34A according to the identity IDA transmitted from the input interface 52, and make a connection with the host 34A. As mentioned above, the radio module 48K can send out a service request packet having the identity IDA to the radio module 48A of the host 34A to request the handshaking procedure.

Step 106: after making the connection with the host 34A in step 104, the data that the user inputted via the input interface 52 will be transferred to a control signal 56A (refer to FIG. 2). The control circuit 50 will then encode the control signal 56A, transfer the control signal 56A to a control signal 56B, packet the control signal 56B and the identity IDA of the host 34A as well in a packet 60, and transmit the radio packet 60 to the host 34A. It is possible that the host 34B (or other hosts) receives the packet 60, but other modules will discard the packet 60 because the identity IDA of the packet has designated the target host. Moreover, other hosts may not be capable of resolving the packet 60 because an encryption method or a specific modulation is adopted during the connection between the input apparatus 36 and the host 34A. When the above-mentioned encryption method of specific modulation is adopted, the input apparatus 36 can even send a packet only having a code that designates the target host 34A but without the identity IDA. In this case the contents of the packet 60 can be reduced.

Step 108: if the user does not select another host as an input target, the input apparatus 36 will return to step 106, such that the user can continue inputting data to the host 34A. If the user wants to input data to another host (such as the host 34B), the user can select the identity IDB corresponding to the host 34B to the control circuit 50 via the input interface 52.

Step 110: if the user selects the host 34B as a target host, the radio module 48K of the control circuit 50 will transmit a specific packet to close the connection with the host 34A. Then the input apparatus 36 will request a handshaking procedure to make a new connection with the host 34B, and the user can input data and commands to the host 34B via the input interface 52.

The above description shows that the input apparatus 36 of the present invention not only provides wireless input interface without real layouts of transmission lines, but supports input requirement of multiple hosts as well. Since the input apparatus 36 obtains the identities of each hosts from the identity table 58 of the storage device 48K, the input apparatus 36 can support input requirement of multiple hosts as long as the storage device 48K has enough space for storing the identities. For example, if the identity table 58 stores 10 identities, then the user can input to 10 different hosts via the input interface 36.

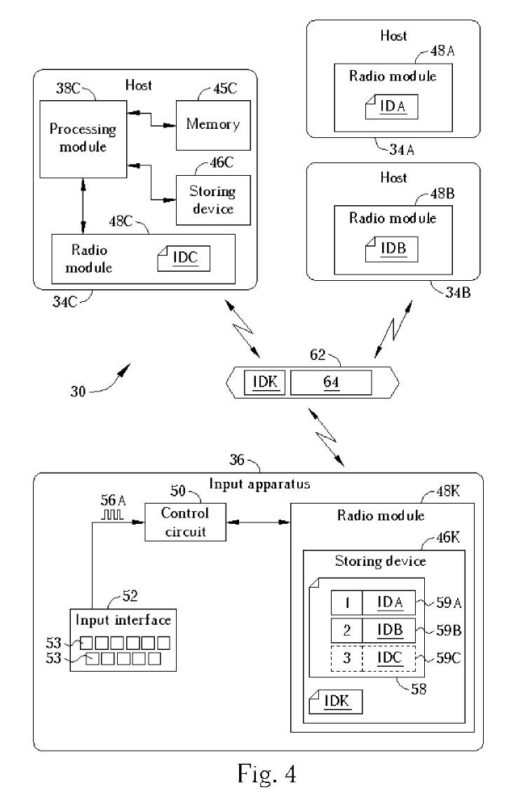

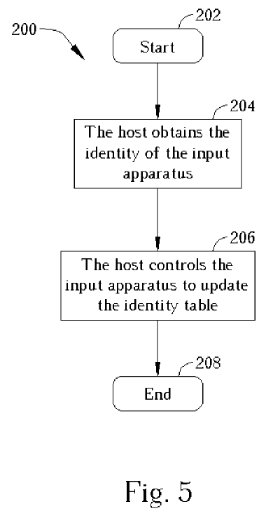

Furthermore, if the user needs to input to a host that the identity of the host is not stored in the identity table 58, the user can update the identity table 58 to store the identity of the host by entering a registration mode. Please refer to FIG. 4 and FIG. 5. FIG. 4 is a function block diagram of the electronic system 30 shown in FIG. 2 combining with a new host 34C. For simplifying description, some function blocks of the hosts 34A and 34B are omitted in FIG. 4. FIG. 5 is a flow chart of the registration mode of the electronic system shown in FIG. 4. As shown in FIG. 4, the host 34C includes a processing module 38C, a volatile memory 45C, a non-volatile storage device 46C, and a radio module 48C. Under the same communication protocol as the radio modules 48A, 48B, and 48K, the radio module 48C also has a unique identity IDC.

When the host 34C is added to the electronic system 30, the user has to enter the registration mode to perform the procedure 200 shown in FIG. 5, so that the identity IDC will be stored in the identity table 58. The procedure 200 is shown as follows:

Step 202: start.

Step 204: the host 34C obtains the identity IDK of the input apparatus 36. The host 34C can obtain the identity IDK by several different ways. For example, the host 34C can send out a service request packet (including the identity IDC) for requesting responses of other radio modules that receive the service request packet, and the input apparatus 36 will send out a service notice packet including the identity IDK and related information (such as information that shows the input apparatus 36 is an input interface) to the host 34C. The host 34C can obtain the identity IDK when receiving the service notice packet. Or the input apparatus 36 can periodically send out a service notice packet including the identity IDK, such that the host 34C can obtain the identity of the input apparatus 36.

Step 206: the host 34C will ask the user if the user wants to utilize the input apparatus 36 as an interface after receiving the identity IDK and other related data. General speaking, each host includes a display for showing messages to the user. When the input apparatus 36 is searched by the host 34C, the user can control the host 34C to update the identity table. In the meantime the radio module 48C of the host 34C will send out a control packet 62 (please refer to FIG. 4) including the identity IDK to the input apparatus 36. Moreover, the control packet 62 also includes a control command 64, which will be resolved by the radio module 48K and executed by the control circuit 50, to add a column 59C for storing the identity IDC of the host 34C in the identity table 58.

Step 208: after updating the identity table 58, the input apparatus 36 can generate a message (such as an indicator light or a specific sound) to notice the user such that the user can control the input apparatus 36 to input mode (i.e. step 100 shown in FIG. 3). The user can select to input to the host 34A, 34B, or 34C by the input apparatus 36. In addition, the input apparatus 36 can send a message to the host 34C after updating the identity table, such that the host 34C can notice the user that the input apparatus 36 has finished updating the identity table. Or the host 34C can control the input apparatus 36 to the input mode by other control packet. If the input apparatus 36 and the host 34C are already connected, the connection can also be closed in this step.

When the procedure 200 is run, if the wireless connection between the host 34C and the input apparatus 36 is built in step 204 and the user wants to continuing input to the host 34C, step 106 can be followed after step 208 to continue inputting data and commands to the host 34C. In addition, if the wireless communication protocol of the radio modules of each host and peripheral devices supports multiple access function, the procedures 100 and 200 can be run simultaneously. For example, the user can execute step 100 to input data to the host 34B by the input apparatus 36, meanwhile, the user can also execute step 200 to update the identity table for storing the identity of the host 34C. But under this situation, the connection between the input apparatus 36 and the host 34C must be closed after finishing step 200 for not interfering with the input to the host 34B.

Besides adding a new column in the identity table 58, the procedure 200 can also be used to edit the identity table 58. In step 206, the user can edit the identity table 58 (such as delete a column, change the identity, exchange two identities with each other in the column table, and add a new column manually) via the input apparatus 36 by changing the control command 64 of the control packet 62. Generally speaking, the hosts are more efficient and have better display than the input apparatus, therefore the user can utilize the better execution ability and better display function to edit the identity table 58, while the input apparatus 36 can just maintain simple hardware that support the input function. For editing the identity table, the user can execute an application program in the host to generate a control command. The control command will then be packeted in a control packet, and transmitted to the control circuit 50 of the input apparatus 36 by the radio module of the host to edit the identity table. While some hosts may not be capable of supporting the application program, the user can still utilize another host to update the identity table. For example, if a new host 34D (a mobile phone) is added to the electronic system 30 shown in FIG. 4. Since the host 34D is a mobile phone, it cannot generate a control packet 36 to edit the identity table 58 of the input apparatus 36. Meanwhile, if the host 34A supports the application program, the user can send a control packet including the identity of the host 34D through the host 34A to the identity table 58 of the input apparatus 36. Wherein the host 34A can obtain the identity of the host 34D by the wireless connection between the host 34A and host 34D.

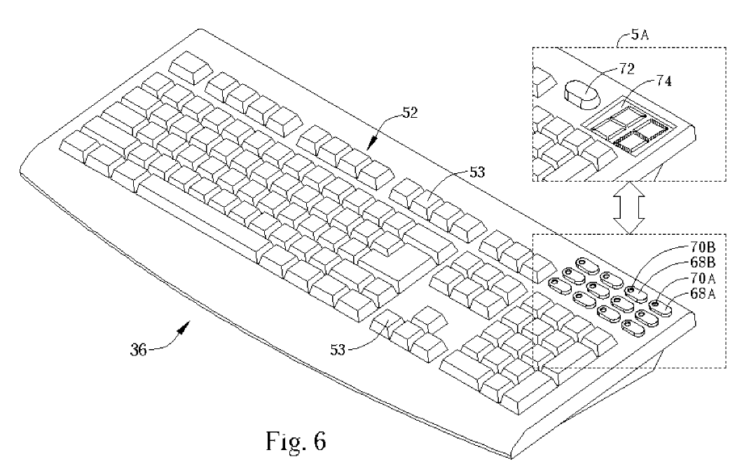

Please refer to FIG. 6 (also FIG. 2 as well). FIG. 6 is a schematic diagram of the input apparatus 36 in an embodiment of the present invention. In the preferred embodiment of the present invention, the input apparatus 36 is a keyboard, and the interface 52 of the input apparatus 36 includes different keys 53. As shown in FIG. 6, switch keys such as 68A and 68B of the input interface 52 are used to control the input apparatus 36 to input to a certain host. For example, when the user presses the switch key 68A, the input interface 52 will select to read out the column 59A in the identity table 58 (refer to FIG. 2), such that the user can input to the host 34A. Similarly, if the user presses the switch key 68B, the user can input data and commands to the host 34B. Additionally, indicator lights (such as 70A and 70B shown in FIG. 6) can be installed in the input apparatus 36 to notice which host the user is inputting to. For example, when the switch key 68A is pressed, the indicator light 70A will be lighted up. Moreover, the switching function of the input interface 52 can be carried out by combining a switch key 72 with one another key in the input interface 52 as shown in FIG. 6A. For example, the user can press the switch key 72 and the key representing “1” in the input interface 52 together to select the column 59A in the identity table 58. Similarly, when the user presses the switch key 72 and the key representing “2” together, the input interface 52 will select the column 59B in the identity table 58 so that the user can input to the host 34B. Furthermore, the switching function of the input interface 52 can also be carried out by key combination. For example, the user can press the “ctrl” key, the “alt” key, and a certain key in the input interface 52 together to select a certain host. And a simple display 74 (such as an LED panel) can be installed in the input interface 52 to show which host the user is inputting. What is more, a message can be shown in the display of the host to show if the host is receiving input data from the input apparatus 36. It is worth noticing that the wireless input apparatus 36 can also be a mouse or a touch pad.

The multiplexer used to support requirement of multiple input of the prior art needs real layouts of transmission lines and has some hardware limitations. Also, the wireless keyboard of the prior art can only support input requirement of single host. In contrast with the prior art, the present invention connects the hosts and the wireless input apparatus with the radio modules under a standard communication protocol, such that the input of multiple hosts is fulfilled. Furthermore, the input apparatus of the present invention does not interfere with other hosts. Since the present invention utilizes wireless network connection instead of real layouts of transmission lines, different hosts (such as mobile phone, PDA, notebook, and PC) are integrated to share a single input interface. For example, in one preferred embodiment of the present invention, the radio modules under bluetooth protocol can be used to transmit packet in high frequency (such as ISM high frequency band around 2.5 GHz).

Those skilled in the art will readily observe that numerous modifications and alterations of the device may be made while retaining the teachings of the invention. Accordingly, the above disclosure should be construed as limited only by the metes and bounds of the appended claims.

What is claimed is:

1. A method of wireless input for supporting a plurality of hosts with a wireless input apparatus, the method comprising:
entering a registration mode;
updating an identity table of the wireless input apparatus; and
supporting the hosts selectively according to the identity table.

2. The method of claim 1, wherein one of the hosts is chosen from the group consisting of the following: a personal computer, a mobile phone, and a personal digital assistant (PDA).

3. An electronic system comprising:
an input apparatus comprising:
a control circuit for controlling the input apparatus;
an input interface for receiving an input information to generate a control signal, and for receiving an identity selected from a plurality of predetermined identities as a transmitting identity;
a storage device for storing an identity table and an identity in a non-volatile way, the identity table comprising a plurality of predetermined identities; and
a first radio module for transmitting a radio packet, the packet comprising the transmitting identity and the control signal; and
a plurality of hosts, each host corresponding to a different host identity, each host comprising:
a second radio module for accepting and outputting the control signal if the packet received from the input apparatus has a corresponding host identity, and discarding the packet if the received packet has no corresponding host identity; and
a processing module electrically connected to the second radio module for receiving the control signal outputted by the second radio module for controlling operations of the host;
wherein at least a processing module of a host among all hosts is capable of controlling the second radio module of the host to transmit a control packet to the input apparatus.

4. The electronic system of claim 3, wherein the control circuit of each host updates the contents of the identity table according to the control packet.

5. The electronic system of claim 3, wherein the input apparatus is a keyboard having a plurality of keys, and the input interface will generate different control signals when different keys are depressed.

6. The electronic system of claim 3, wherein the first radio module is further capable of transmitting a service notice packet comprising an identity code of the input apparatus.

7. The electronic system of claim 6, wherein each host is capable of outputting a noticing signal when receiving the service notice packet.

8. The electronic system of claim 3, wherein each host is capable of transmitting a service request packet with the second radio module.

9. The electronic system of claim 8, wherein the input apparatus will output the service notice packet when receiving the service request packet.

10. The electronic system of claim 3, wherein when a host transmits the control packet comprising an identity code corresponding to the host, the control circuit will add the identity code corresponding to the host in the identity table as a predetermined identity code for updating the identity table.
